(19) United States
(12) Patent Application Publication
(10) Pub. No.: US 2021/0289509 A1
(43) Pub. Date: Sep. 16, 2021

(54) BASE STATION AND SIGNAL TRANSMISSION METHOD

(71) Applicant: NTT DOCOMO, INC., Tokyo (JP)

(72) Inventors: Keisuke SAITO, Tokyo (JP); Kazuki TAKEDA, Tokyo (JP); Satoshi NAGATA, Tokyo (JP)

(73) Assignee: NTT Docomo, INC., Tokyo (JP)

(21) Appl. No.: 16/319,507

(22) PCT Filed: Jul. 20, 2017
(86) PCT No.: PCT/JP2017/026206

§ 371 Date: Jan. 22, 2019

(30) Foreign Application Priority Data
Aug. 10, 2016 (JP) 2016-158270

(51) Int. Cl. H04W 72/08; H04W 72/04; H04W 72/12; H04L 5/00; H04L 27/26; H04W 24/10

(52) U.S. Cl. CPC H04W 72/082; H04W 72/0453; H04W 24/10; H04L 5/0051; H04L 27/26025; H04W 72/1263

(57) ABSTRACT

A base station includes a determiner that determine a first specific resource position at which a radio signal is muted in a first cell, based on a first resource position of a first reference signal configured in the first cell, a first resource allocation of the first cell, a second resource position of a second reference signal configured in a second cell, and a second resource allocation of the second cell; and a transmitter that transmits the radio signal in the first cell, while mapping the first reference signal onto a first resource at the first resource position of the first reference signal configured in the first cell, and muting a specific resource at the first specific resource position at which the radio signal is muted in the first cell.

### TECHNICAL FIELD

The present invention relates to a base station and a signal transmission method.

### BACKGROUND ART

In Long Term Evolution (LTE), in order to further increase a system capacity, further increase a data transmission rate, and further reduce latency in a radio section, a radio communication scheme called 5G has been studied. In 5G, various radio technologies have been studied in order to satisfy requirements that latency of a radio section should be reduced to be less than or equal to 1 ms while achieving throughput of higher than or equal to 10 Gbps. Since it is highly likely that a radio technology other than LTE is employed in 5G, in 3GPP, a radio network supporting 5G is called a new radio network (new radio access network (NeWRAT)) to be distinguished from a radio network supporting LTE.

In 5G, in order to achieve ultra high speed, large capacity, and ultra low latency, in addition to the existing low frequency band, use of a high frequency band has been studied, in which a wide band can be easily secured. In the high frequency band, influence of a phase noise is large, and, thus, it has been studied to increase a subcarrier spacing to be larger than that in LTE for a carrier (cell) using the high frequency band.

### PRIOR ART DOCUMENT

### Non-Patent Document

Non-Patent Document 1: NTT DoCoMo, Inc. “Docomo 5G White Paper,” September 2014
Non-Patent Document 2: NTT Docomo, NTT DOCOMO Technical Journal “5G radio access technology,” January 2016

### SUMMARY OF THE INVENTION

### Problem to be Solved by the Invention

As described above, in order to support a wide frequency band in 5G, different numerologies may be applied to respective cells (FIG. 1). Accordingly, a configuration of a reference signal (RS) used for channel estimation, quality measurement, etc., is assumed to be set based on the numerology applied to each cell. The numerology indicates a subcarrier spacing, a symbol length, and a cyclic prefix (CP) length. Application of different numerologies to respective cells implies that subcarrier spacing, symbol lengths, and CP lengths of respective cells are different from each other.

Here, in LTE, a mechanism that allows user equipment to appropriately measure a reception quality of a serving cell and an interference signal from a neighbor cell by muting some resources of the cell is specified. For example, as illustrated in FIG. 2, when resources in which the reference signal is transmitted in a cell #1 are set to be muted in a cell #2, the user equipment can measure the interference signal from the neighboring cell by measuring the muted resources, and when the reference signal is measured in the serving cell, the reference signal can be measured without being affected by the interference signal from the neighbor cell.

In the case of LTE, basically, since a numerology in which the subcarrier spacing is 15 kHz is applied to each cell, the sizes of resource elements are also the same between cells. However, in 5G, when different numerologies are applied to respective cells, the sizes of the resource elements (the sizes of grids illustrated in FIG. 1) are different between cells, and, thus, it may be unable to appropriately measure the reference signal and the interference signal unless positions of resources to be muted are set appropriately.

There is a need for a technique that allows user equipment to appropriately measure a reference signal and an interference signal in accordance with a numerology applied to each cell.

### Means for Solving the Problem

A base station according to the disclosed technology is a base station of a radio communication system including a plurality of cells, the base station including a determiner that determines a first specific resource position at which a radio signal is muted in a first cell based on a first resource position of a first reference signal configured in the first cell, a first resource allocation of the first cell, a second resource position of a second reference signal configured in a second cell, and a second resource allocation of the second cell; and a transmitter that transmits the radio signal in the first cell, while mapping the first reference signal onto a first resource at the first resource position of the first reference signal configured in the first cell, and muting a specific resource at the first specific resource position at which the radio signal is muted in the first cell.

### Advantage of the Invention

According to the disclosed technology, a technique is provided that is allows user equipment to appropriately measure a reference signal and an interference signal in accordance with a numerology applied to each cell.

### BRIEF DESCRIPTION OF DRAWINGS

FIG. 1 is a diagram illustrating an example of numerologies applied to respective cells;

FIG. 2 is a diagram illustrating an example when some resources are muted in LTE;

FIG. 3 is a diagram illustrating an example of a configuration of a radio communication system according to an embodiment;

FIG. 4 is a sequence diagram illustrating an example of a processing procedure performed in a radio communication system according to an embodiment;

FIG. 5 is a diagram for describing a first specific example;

FIG. 6 is a diagram for describing a second specific example;

FIG. 7 is a diagram for describing a third specific example;

FIG. 8 is a diagram for describing a fourth specific example;

FIG. 9 is a diagram for describing a fifth specific example;

FIG. 10 is a diagram for describing a fifth specific example (a modified example);

FIG. 11 is a diagram for describing a sixth specific example;

FIG. 12 is a diagram for describing a seventh specific example;

FIG. 13 is a diagram for describing a seventh specific example (a modified example);

FIG. 14 is a diagram for describing an eighth specific example;

FIG. 15 illustrates an example of a table indicating resource positions for each index number;

FIG. 16 is a diagram illustrating an example of a functional configuration of a base station according to an embodiment;

FIG. 17 is a diagram illustrating an example of a functional configuration of a user equipment according to an embodiment; and

FIG. 18 is a diagram illustrating an example of a hardware configuration of each of a base station and a user equipment according to an embodiment.

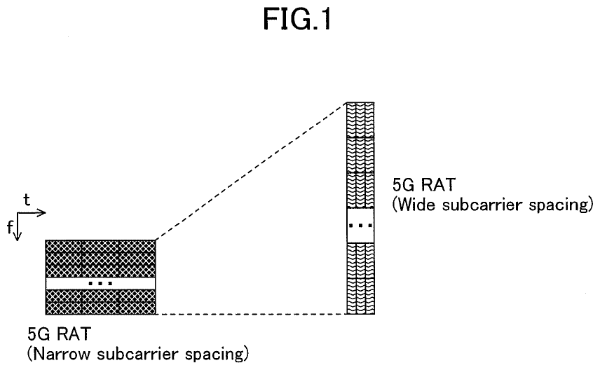

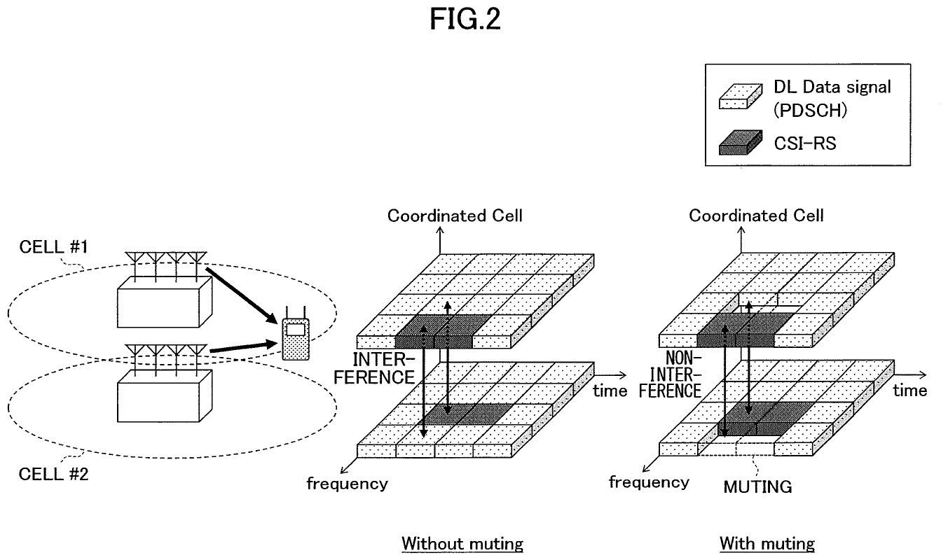

### EMBODIMENTS OF THE INVENTION

In the following, an exemplary embodiment of the present invention is described by referring to the drawings. An embodiment to be described below is merely an example, and an embodiment to which the present invention is applied is not limited to the following embodiment. For example, a radio communication system according to the present embodiment is assumed to be a system that supports LTE and 5G, but the present invention is not limited to LTE and 5G and applicable to other schemes. In this specification and claims set forth below, “LTE” is used in a broad sense including Releases 10, 11, 12, and 13 of 3GPP or a 5th generation communication scheme corresponding to Release 14 or later in addition to communication schemes corresponding to Release 8 and 9 of 3GPP. In the following description, “resources” are used to indicate radio resources.

<System Configuration>

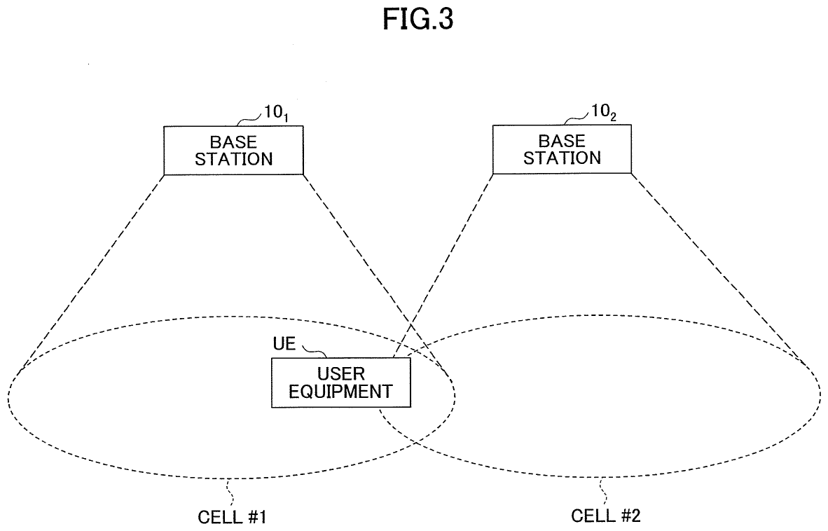

FIG. 3 is a diagram illustrating an example of a configuration of a radio communication system according to an embodiment. As illustrated in FIG. 3, the embodiment radio communication system includes a base station 10₁ forming a cell #1, a base station 10₂ forming a cell #2, and a user equipment UE. In the following description, when it is unnecessary to distinguish the base station 10₁ and the base station 10₂, they are referred to as a “base station 10.” The number of base stations 10 is not limited to two and may be three or more.

The user equipment UE has a function of communicating with the base station 10 and a function of measuring a reception quality of the cell and/or an interference amount from a neighbor cell using the reference signal transmitted from the base station 10 and reporting the reception quality and the interference amount to the base station 10.

The base station 10₁ and the base station 10₂ can apply the same numerology or different numerologies to respective cells. In the present embodiment, the numerology set in each cell may be any subcarrier spacing, any symbol length, and any CP length.

The base station 10₁ and the base station 10₂ can communicate with each other using an inter-base station interface. The base station 10₁ and the base station 10₂ give a notification indicating a resource position in which the reference signal is set and information related to a resource allocation based on the numerology to each other and thus can detect the resource position in which the reference signal is transmitted from the other base station 10 among its own radio resources.

In an example of FIG. 3, the base station 10₁ and the base station 10₂ are illustrated as two base stations, but the base station 10₁ and the base station 10₂ may be configured as one base station 10. In this case, one base station 10 forms the cell #1 and the cell #2. Carrier frequencies and bandwidths of the cell #1 and the cell #2 are arbitrary, but in the present embodiment, it is assumed that a band of the cell #1 and a band of the cell #2 overlap entirely or partially, and the user equipment UE may be interfered by the other cell in an area in which areas of the respective cells overlap such as a cell edge.

Further, it is also possible to construct an aggregated base station on a layer higher than the base station 10₁ and the base station 10₂. In this case, the area is formed by the base station 10₁ and the base station 10₂, but a role related to control such as allocation of resources is performed by aggregated base station.

<Processing Procedure>

### (Reference Signal)

The reference signal transmitted from the base station 10 may be any reference signal. For example, the reference signal may be a cell-specific reference signal, a reference signal for channel state information (CSI) measurement, or a reference signal for demodulation. Further, similar to LTE, the reference signal may be called a cell specific-RS (CRS), may be called a CSI-RS, or may be called a demodulation RS (DM-RS).

In the present embodiment, the base station 10 is assumed to detect the resource position of the reference signal configured in the cell formed by the base station 10 (which may be referred to as a “reference signal configuration”) in a memory, etc., in advance through an operation & maintenance (O&M) device, etc.

(Processing Sequence)

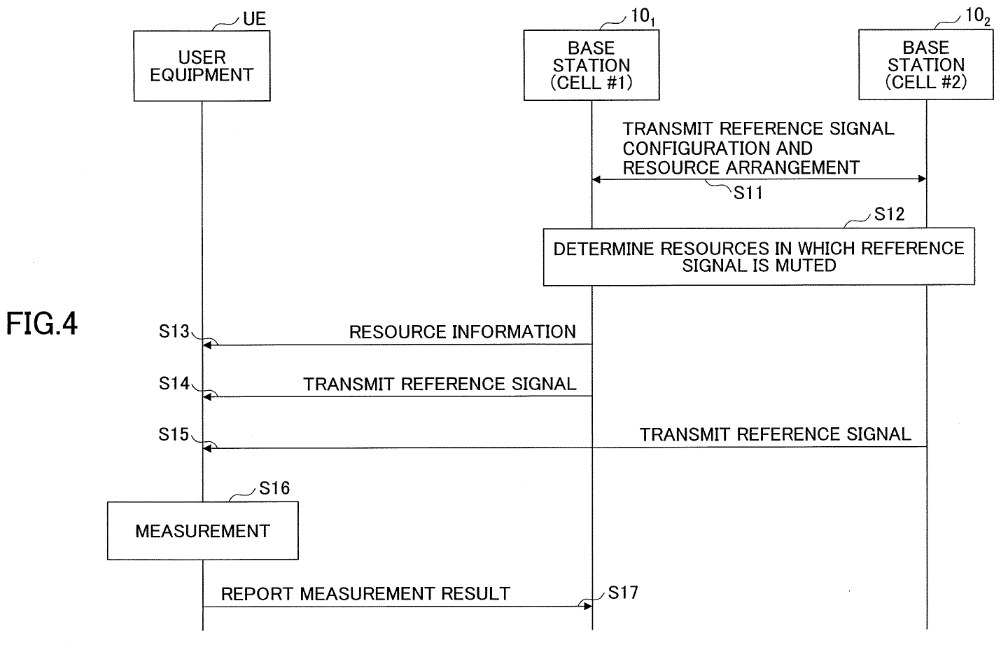

Next, a processing procedure performed in the radio communication system according to the embodiment is specifically described. FIG. 4 is a sequence diagram illustrating an example of a processing procedure performed in the radio communication system according to the embodiment. FIG. 4 is under the assumption that the user equipment UE resides in the cell #1 and the cell #2 is a cell adjacent to the cell #1.

In step S11, the base station 10₁ and the base station 10₂ transmit information related to a resource position in which a reference signal is configured in its own cell and a resource allocation of its own cell to each other via the inter-base station interface. The information related to the resource allocation includes information related to the numerology (for example, the subcarrier spacing, the symbol length, and the CP length), information related to a carrier frequency, a bandwidth, and an offset in the time direction (for example, an offset between a predetermined reference time and a start timing of a radio frame, etc.), and so forth.

The base station 10₁ and the base station 10₂ obtains the resource position in which the reference signal is configured and the information related to the resource allocation from the other base station 10 and, thus, can detect how the resources (resource grids) of its own base station 10 and the resources (resource grids) of the other base station 10 overlap. In the process of step S11, instead of exchanging the information related to the resource allocation directly between the base stations 10, a notification of the information related to the resource allocation of the other base station 10 is given to each base station 10 using an O & M device, etc.

In step S12, the base station 101 determines a first specific resource position at which a radio signal is muted in the cell #1 based on a resource position of a first reference signal configured in the cell #1; a first resource allocation configured in the cell #1, a second resource position of a second reference signal configured in the cell #2, and a second resource allocation configured in the cell #2.

Similar to the base station 101, the base station 102 also determines a second specific resource position at which a radio signal is muted in the cell #2. The base station 102 is not required to determine the second specific resource position at which a radio signal is muted in the cell #2, and the base station 101 may determine the second specific resource position at which a radio signal is muted in the cell #2. When the base station 101 and the base station 102 form a single base station 10, the procedures at step S11 and step S12 are performed as an internal process of the base station 10.

In step S13, the base station 101 transmits (configures), to the user equipment UE, information (hereinafter, referred to as “resource information”) including the first resource position at which the first reference signal is transmitted in the cell #1 and the first specific resource position at which a radio signal is muted in the cell #1. The the resource information may be transmitted to the user equipment UE through broadcast information or may be transmitted using individual radio resource control (RRC) signaling. Similarly, for the user equipment UE residing in the cell #2, the base station 102 may transmit (configure), to the user equipment UE residing in the cell #2, information (resource information) including the second resource position at which the second reference signal is transmitted in the cell #2 and the second specific resource position at which a radio signal is muted in the cell #2.

In step S14, the base station 101 maps the first reference signal to the first resource at the first resource position of the first reference signal configured in the cell #1, and, further, mutes the first specific resource at the the first specific resource position determined in the step S12, and transmits the radio signal of the cell #1.

In step S15, the base station 102 maps the second reference signal to the second resource at the second resource position of the second reference signal configured in the cell #2, and, further, mutes the second specific resource at the second specific resource position determined in the step S12, and transmits the radio signal of the cell #2.

In step S16, the user equipment UE performs the quality measurement of the first reference signal of the serving cell (the cell #1) based on the resource information transmitted at step S13 and measures the muted resource, so as to measure an interference amount from the neighbor cell (the cell #2).

In step S17, the user equipment UE reports the measurement result measured in step S16 to the base station 10₁.

(Muted Resource Position Determination Method)

Next, a method of deciding the resource position at which a radio signal is muted through the base station 10 in the processing procedure of step S12 in FIG. 4 is described. The base station 10 determines the resource position by one of the following methods.

In the following resource position determination method, the “reference signal” refers to a “reference signal group” configured with a plurality of reference signals which are associated with different antenna ports. In other words, “one reference signal” means that the “number of reference signal group” is one, and “a plurality of reference signals” means that the “number of reference signal groups” is two or more. However, in the present embodiment, it is also possible to apply the “reference signal” without limiting it to such a reference signal group.

[First Mute Resource Position Determination Method]

STEP 1: When a plurality of reference signals is configured in each predetermined resource unit of the cell #1, a resource position of a part of the reference signals among the resource positions of the plurality of reference signals is determined as the first specific resource position at which a radio signal is muted in the cell #1. If only one reference signal is configured in a predetermined resource unit of the cell #1, the radio signal is determined not to be muted in the cell #1.

STEP 2: A resource position at which a reference signal other than the part of the reference signals is transmitted among the resource positions of the plurality of reference signals configured in a predetermined resource unit of the cell #1 (that is, a resource position which is not muted among the resource positions of the plurality of reference signals configured in the predetermined resource unit of the cell #1) is determined as a second specific resource position at which a radio signal is muted in the cell #2.

[Second Mute Resource Position Determination Method]

STEP 1: By comparing the resource allocation of the cell #1 with the resource allocation of the cell #2, a resource including a resource position in which a reference signal is configured in the cell #2 is identified within the predetermined resource unit of the cell #1, and the identified resource is determined to be a first specific resource position at which a radio signal is muted in the cell #1.

STEP 2: When a plurality of reference signals of the cell #1 is configured within the predetermined resource unit of the cell #1 in STEP 1, a part of the resource positions among the resource positions of the plurality of reference signals of the cell #1 is determined to be a second specific resource position at which a radio signal is muted in the cell #2.

In the first and second mute resource position determination methods, the base station 10 may decide the resource position to be muted in accordance with the “first mute resource position determination method” or the “second mute resource position determination method,” then switch the cell #1 “and” the cell #2, and perform a similar determination method repeatedly. Further, when the base station 10₁ forms the cell #1, and the base station 10₂ forms the cell #2, the base station 10₁ may perform STEP 1, and the base station 10₂ may perform STEP 2. Further, both STEP 1 and STEP 2 may be performed by the base station 10₁, and the determined second specific resource position in which the radio signal is muted in the cell #2 may be transmitted (indicated) from the base station 10₁ to the base station 10₂ via the inter-base station interface. Furthermore, the order of STEP 1 and STEP 2 may be reversed (in order of STEP 2 and STEP 1). Furthermore, STEP 1 and STEP 2 may be performed separately. Namely, three types of control, i.e., a case in which only STEP 1 is performed, a case in which only STEP 2 is performed, and a case in which both STEP 1 and STEP 2 are performed, may be independently executed. Furthermore, the resources in which STEP 1 and STEP 2 are performed may not be consecutive intervals in the time/frequency domain.

### SPECIFIC EXAMPLES

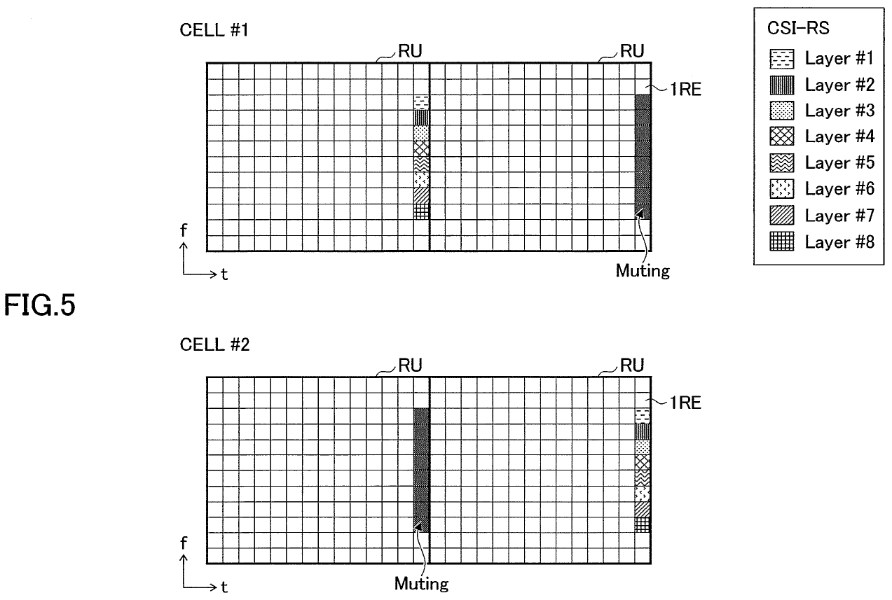

Next, specific examples of determining, by the base station 10 using the above-described procedure, a resource position at which a radio signal is muted are described using FIG. 5 through FIG. 14.

Here, one grid illustrated in FIG. 5 through FIG. 14 corresponds to a resource element which is a minimum resource unit. One resource element can also be indicated as resources surrounded by one subcarrier in the frequency direction and one symbol in the time direction. Further, in the examples of FIGS. 5 to 14, a range surrounded by 12 resource elements in the frequency direction and 14 resource elements in the time direction is defined as a resource unit (RU). One RU is a unit which is intended to be a minimum resource allocation unit and corresponds to a resource block (RB) in LTE. The “predetermined resource unit” in the first and second mute resource position determination methods is assumed to be a pair of RUs (two consecutive RUs) in the following specific examples.

Further, the examples of FIGS. 5 to 14 are on the assumption that the reference signal is configured in 8 resource elements at the center among the 12 resource elements in the frequency direction in any symbol in the RU for each RU. Further, the reference signals configured using the 8 resource elements are assumed to be associated with different lavers (antenna ports) for each resource element. The resource positions of the reference signals illustrated in FIGS. 5 to 14 are configured for the sake of convenience in order to describe the specific examples, and the present invention is not limited thereto. The present embodiment can be applied to any resource position in which the reference signal is configured.

### First Specific Example

A first specific example is a specific example for determining the resource position at which a radio signal is muted using the “first mute resource position determination method.” In the first specific example, the numerologies and the resource positions of the reference signals of the cell #1 and the cell #2 are assumed to be identical to each other.

FIG. 5 is a diagram for describing the first specific example. First, the base station 10 determines the reference signal configured in the right RU among a plurality of reference signals configured in the predetermined resource units (a pair of RUs) of the cell #1 (the reference signal configured in the left RU and the reference signal configured to in the right RU) as a first specific resource position at which a radio signal is muted in the cell #1 (STEP 1). Subsequently, the base station 10 determines the resource position which is not muted among the resource positions of a plurality of reference signals in the cell #1 (that is, the resource position of the reference signal configured in the left RU) as a second specific resource position at which a radio signal is muted in the cell #2 (STEP 2). In the first specific example, a similar resource position is determined to be muted, even if the “second mute resource position determination method” is applied.

### Second Specific Example

A second specific example is a specific example for determining the resource position at which a radio signal is muted using the “first mute resource position determination method.” In the second specific example, the numerologies of the cell #1 and the cell #2 are assumed to be identical to each other, but the resource positions of the reference signals of the cell #1 and the cell #2 are assumed to be different from each other.

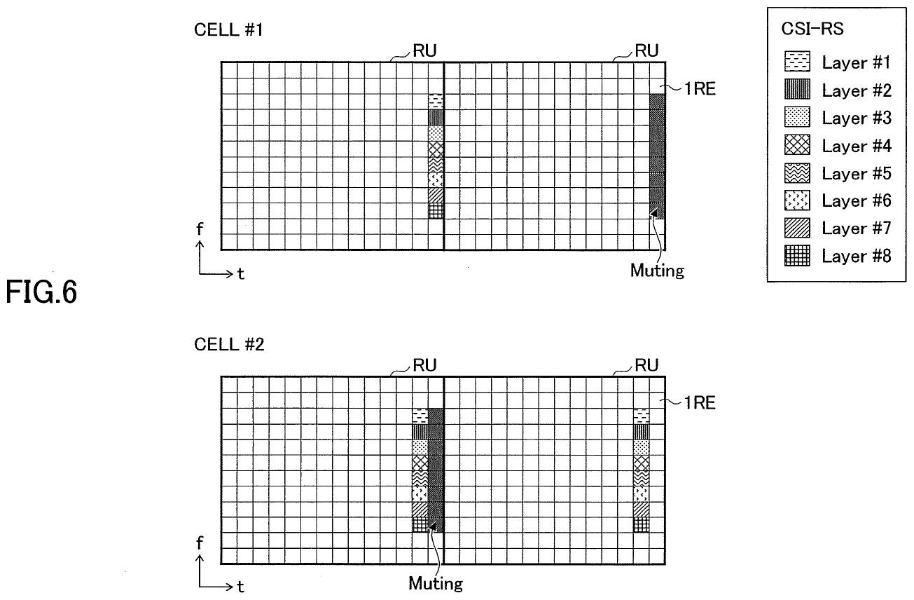

FIG. 6 is a diagram for describing the second specific example. First, the base station 10 determines the reference signal configured in the right RU among a plurality of reference signals configured in the predetermined resource units (a pair of RUs) of the cell #1 (the reference signal configured in the left RU and the reference signal configured in the right RU) as a first specific resource position at which a radio signal is muted in the cell #1 (STEP 1). Then, the base station 10 determines the resource position which is not muted among the resource positions of a plurality of reference signals in the cell #1 (that is, the resource position of the reference signal configured in the left RU) as a second specific resource position at which a radio signal is muted in the cell #2 (STEP 2). In the second specific example, the user equipment UE that measures the interference amount in the cell #1 measures the interference amount of the signal, a noise, etc., transmitted through the data channel of the cell #2.

### Specific Example 3

A third specific example is a specific example for determining the resource position at which a radio signal is muted using the “second mute resource position determination method.” In the third specific example, similar to the second specific example, the numerologies of the cell #1 and the cell #2 are assumed to be identical to each other, but the resource positions of the reference signals of the cell #1 and the cell #2 are assumed to be different from each other.

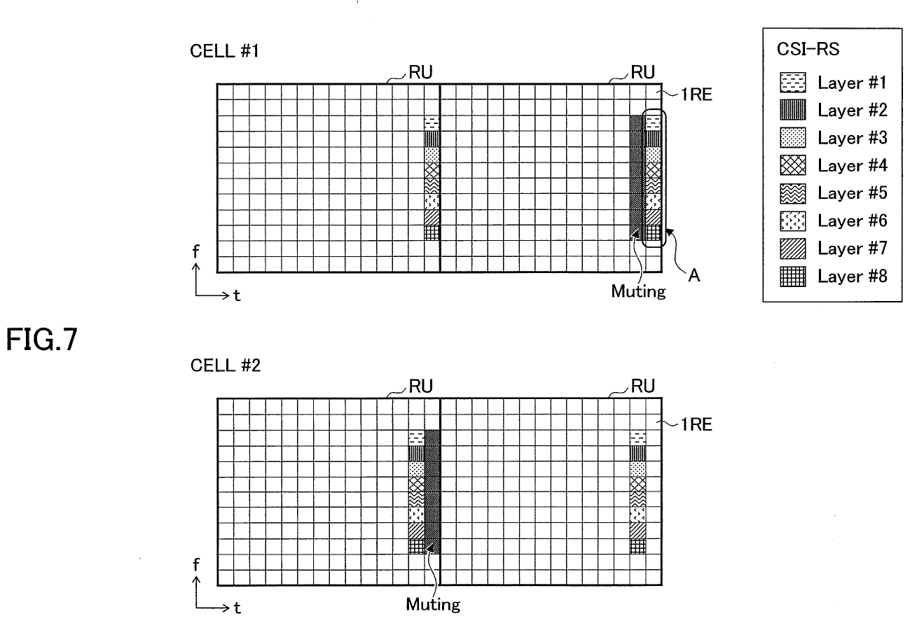

FIG. 7 is a diagram for describing the third specific example. First, the base station 10 compares the resource allocation of the cell #1 with the resource allocation of the cell #2, specifies resources including the resource position in which the reference signal is configured in the cell #2 in the predetermined resource units (a pair of RUs) of the cell #1, and determines the specified resources (resources of a second symbol from the last symbol in the right RU of the cell #1 in the example of FIG. 7) as a first specific resource position at which a radio signal is muted in the cell #1 (STEP 1). Then, the base station 10 determines some resource positions (the resource position of the reference signal configured in the left. RU in the example of FIG. 7) among a plurality of reference signals configured in the predetermined resource units (a pair of RUs) of the cell #1 (the reference signal configured in the left RU and the reference signal configured in the right RU) as a second specific resource position at which a radio signal is muted in the cell #2 (STEP 2).

In the case of the third specific example, since the resource position at which the radio signal is determined to be muted in the cell #1 does not overlap the resource position in which the reference signal is configured in the predetermined resource units of the cell #1 (the left RU and the right RU), a plurality of reference signals are transmitted in a pair of RUs in the cell #1. In this case, the base station 10 may transmit the signal of the data channel instead of some reference signals (“A” in FIG. 7) among a plurality of reference signals in the cell #1. Accordingly, it is possible to increase the amount of data that can be transmitted through the downlink while maintaining a satisfactory quality measurement accuracy using the reference signal.

### Fourth Specific Example

A fourth specific example is a specific example for determining the resource position at which a radio signal is muted using the “first mute resource position determination method.” In the fourth specific example, the resource positions of the reference signals of the cell #1 and the cell #2 are assumed to be identical to each other, but the numerologies of the cell #1 and the cell #2 are assumed to be different from each other. It is assumed that the subcarrier spacing of the cell #2 is half that of the cell #1, and the symbol interval of the cell #2 is twice that of the cell #1 (the same applies to the following fifth to eighth specific examples).

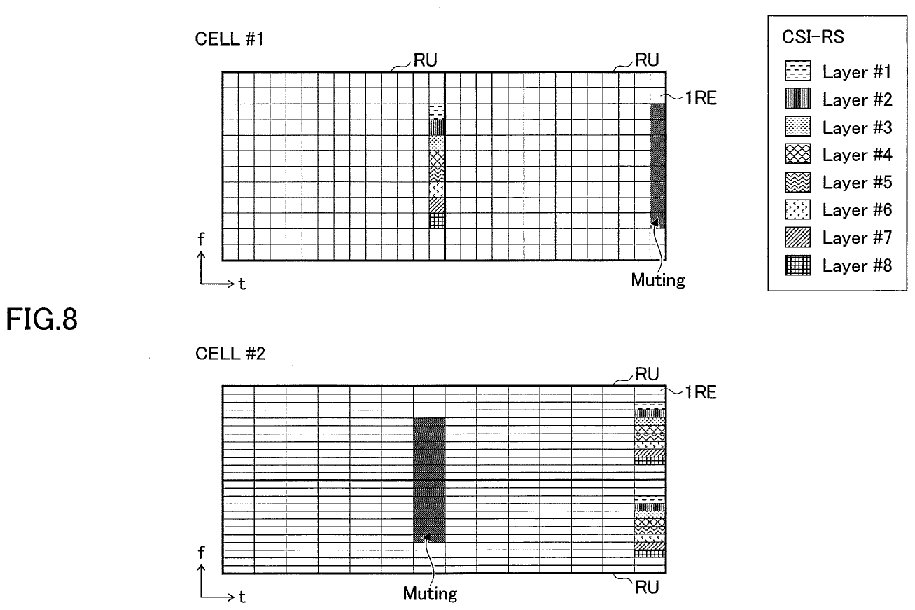

FIG. 8 is a diagram for describing the fourth specific example. First, the base station 10 determines the reference signal configured in the right RU among a plurality of reference signals configured in the predetermined resource units (a pair of RUs) of the cell #1 (the reference signal configured in the left RU and the reference signal configured in the right RU) as a first specific resource position at which a radio signal is muted in the cell #1 (STEP 1). Then, the base station 10 determines the resource position which is not muted among the resource positions of a plurality of reference signals in the cell #1 (that is, the resource position of the reference signal configured in the left RU) as a second specific resource position at which a radio signal is muted in the cell #2 (STEP 2). In the example of FIG. 8, since the numerologies of the cell #1 and the cell #2 are different from each other, the positions of the resource elements of the cell #1 and the cell #2 are not identical. Accordingly, the base station 10 determines the second specific resource position at which a radio signal is muted in the cell #2 to be a range that includes all the resource positions at which muting is not applied at least in the cell #1.

### Fifth Specific Example

A fifth specific example is a specific example for determining the resource position at which a radio signal is muted using the “first mute resource position determination method.” In the fifth specific example, similar to the fourth specific example, the resource positions of the reference signals of the cell #1 and the cell #2 are assumed to be identical to each other, but the numerologies of the cell #1 and the cell #2 are assumed to be different from each other.

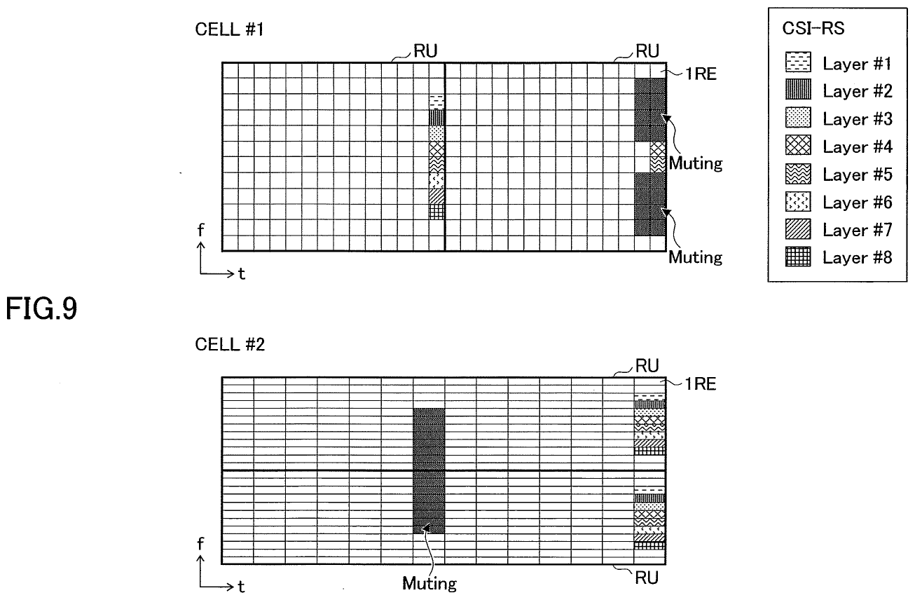

FIG. 9 is a diagram for describing the fifth specific example. First, the base station 10 compares the resource allocation of the cell #1 with the resource allocation of the cell #2, specifies resources including the resource position in which the reference signal is configured in the cell #2 in the predetermined resource units (a pair of RUs) of the cell #1, and determines the specified resources (resources of the last symbol and resources of a second symbol from the last symbol in the right RU of the cell #1 in the example of FIG. 9) as a first specific resource position at which a radio signal is muted in the cell #1 (STEP 1). Then, the base station 10 determines a part of resource positions (the resource position of the reference signal configured in the left RU in the example of FIG. 7) among a plurality of reference signals configured in the predetermined resource units (a pair of RUs) of the cell #1 (the reference signal configured in the left RU and the reference signal configured in the right RU) as a second specific resource position at which a radio signal is muted in the cell #2 (STEP 2).

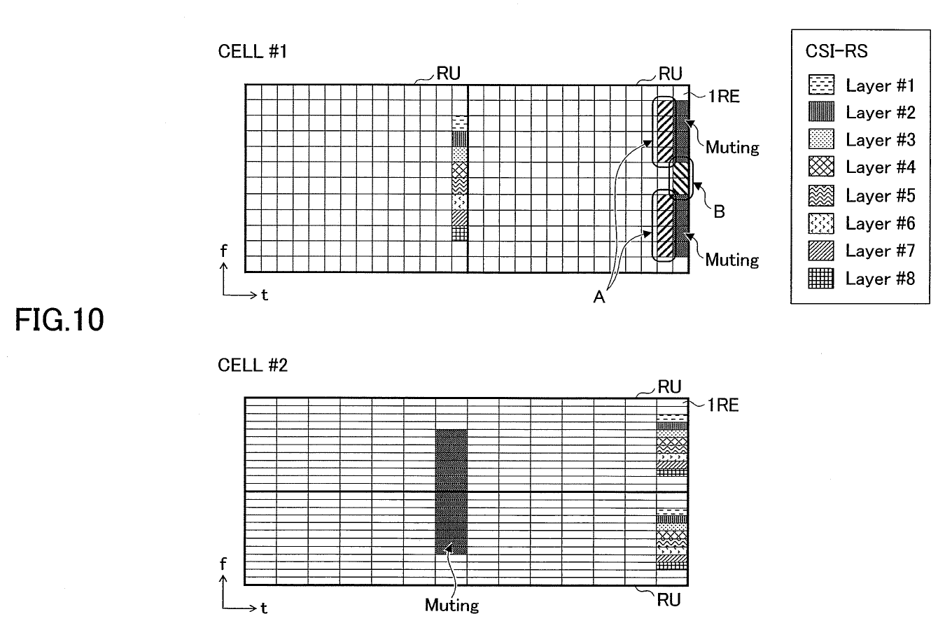

In the case of the fifth specific example, as illustrated in FIG. 10, a data channel signal may be transmitted at a part of the first specific resource position (e.g., “A” in FIG. 10) which is determined to be the position at which a radio signal is muted in the cell #1, or the reference signal that is determined to be muted may be transmitted at A. Further, the base station 10 may also use the resource element of the reference signal set to be muted in the cell #1 (“B” in FIG. 10) for transmission of the data channel. Accordingly, it is possible to increase the amount of data that can be transmitted through the downlink. The base station 10 may mute the resource element of “B” in FIG. 10.

### Sixth Specific Example

A sixth specific example is a specific example for determining the resource position at which a radio signal is muted using the “first mute resource position determination method.” In the sixth specific example, the numerologies and the resource positions of the reference signals of the cell #1 and the cell #2 are assumed to be different from each other.

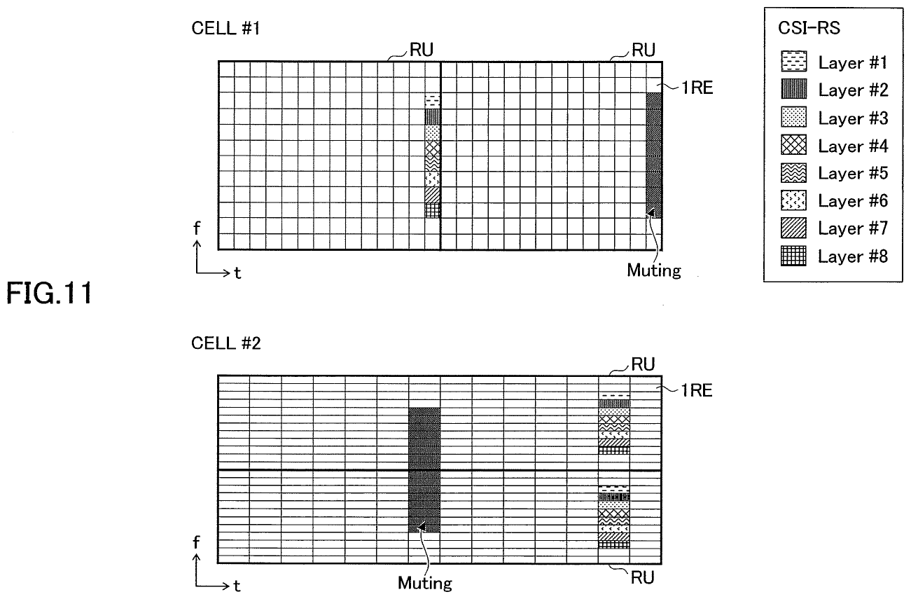

FIG. 11 is a diagram for describing the sixth specific example. First, the base station 10 determines the reference signal configured in the right RU among a plurality of reference signals configured in the predetermined resource units (a pair of RUs) of the cell #1 (the reference signal configured in the left RU and the reference signal configured in the right RU) as a first specific resource position at which a radio signal is muted in the cell #1 (STEP 1). Then, the base station 10 determines the resource position which is not muted among the resource positions of a plurality of reference signals in the cell #1 (that is, the resource position of the reference signal configured in the left RU) as a second resource position at which a radio signal is muted in the cell #2 (STEP2). In the sixth specific example, the user equipment UE that measures the interference amount in the cell #1 measures the interference amount of the signal, a noise, and the like transmitted through the data channel of the cell #2.

### Seventh Specific Example

A seventh specific example is a specific example for determining a resource position at which a radio signal is muted using the “second mute resource position determination method.” In the seventh specific example, the numerologies and the resource positions of the reference signals of the cell #1 and the cell #2 are assumed to be different from each other.

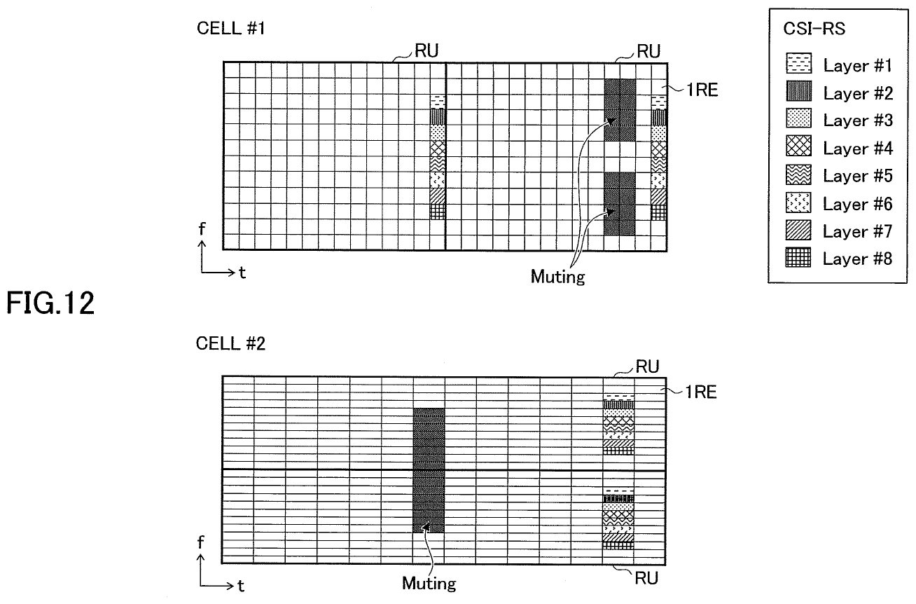

FIG. 12 is a diagram for describing the seventh specific example. First, the base station 10 compares the resource allocation of the cell #1 with the resource allocation of the cell #2, specifies resources including the resource position in which the reference signal is configured in the cell #2 in the predetermined resource units (a pair of RUs) of the cell #1, and determines the specified resources (resources of the last symbol and resources of third and fourth symbols from the last symbol in the right RU of the cell #1 in the example of FIG. 12) as a first specific resource position at which a radio signal is muted in the cell #1 (STEP 1). Then, the base station 10 determines some resource positions (the resource position of the reference signal configured in the left RU in the example of FIG. 12) among a plurality of reference signals configured in the predetermined resource units (a pair of RUs) of the cell #1 (the reference signal configured in the left RU and the reference signal configured in the right RU) as a second specific resource position at which a radio signal is muted in the cell #2 (STEP 2).

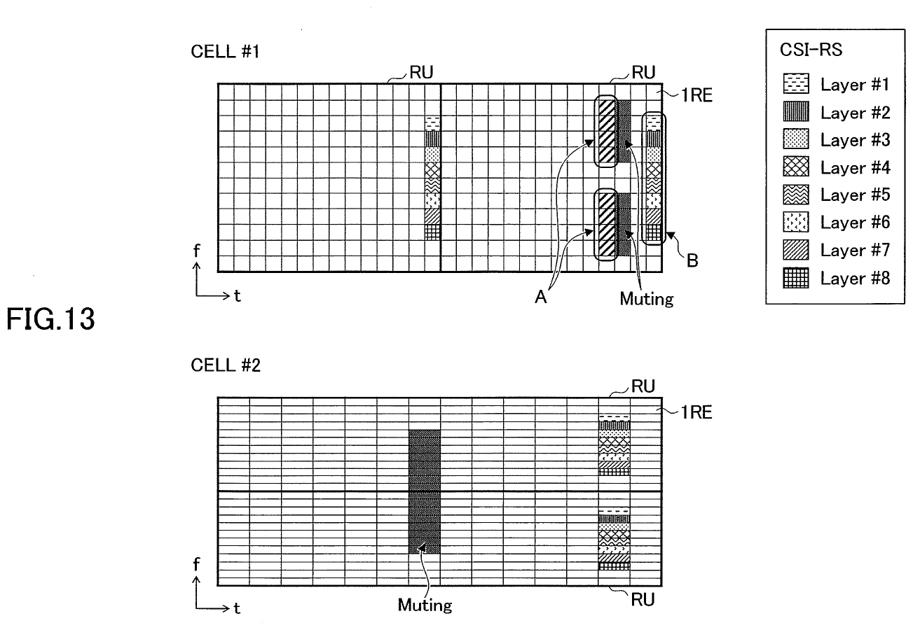

In the case of the seventh specific example, as illustrated in FIG. 13, a data channel signal may be transmitted at a part of the first specific resource position (for example, “A” in FIG. 13) among the resource positions at which a radio signal is determined to be muted in the cell #1. Further, in the case of the seventh specific example, similar to the third specific example, a plurality of reference signals are transmitted in the cell #1. In this case, the base station 10 may transmit the signal of the data channel signal instead of some reference signals (“B” in FIG. 13) among a plurality of reference signals in the cell #1. Accordingly, it is possible to increase the amount of data that can be transmitted through the downlink while maintaining a certain level of quality measurement accuracy using the reference signal.

### Eighth Specific Example

In the fourth to seventh specific examples described above, the base station 10 determines the resource position at which a radio signal is muted starting from the cell #1, but may determine the resource position at which a radio signal is muted starting from the cell #2.

An eighth specific example is a specific example for determining the resource position at which a radio signal is muted using the “first mute resource position determination method.” In the eighth specific example, the numerologies and the resource positions of the reference signals of the cell #1 and the cell #2 are assumed to be different from each other.

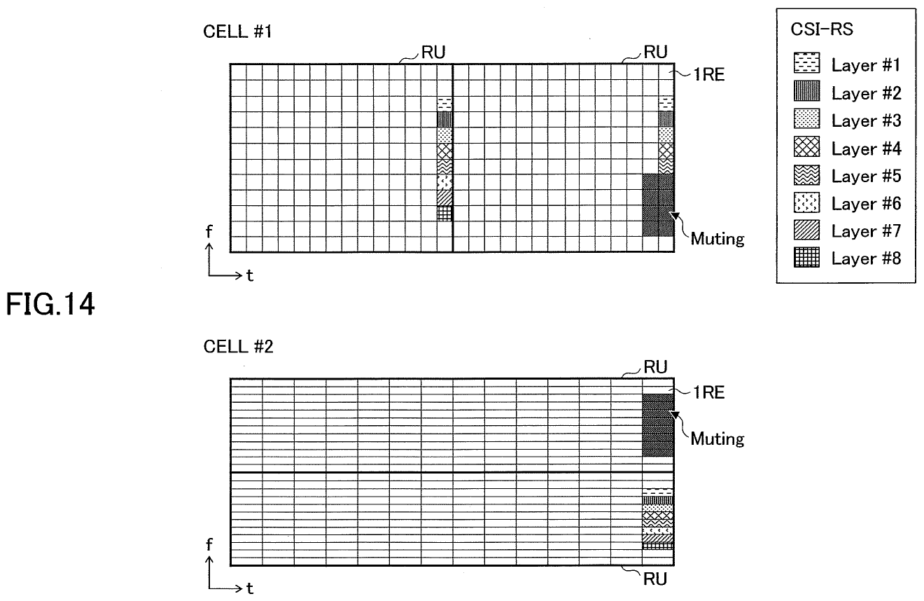

FIG. 14 is a diagram for describing the eighth specific example. First, the base station 10 determines the reference signal configured in the right RU among a plurality of reference signals configured in the predetermined resource units (a pair of RUs in the frequency direction) of the cell #1 (the reference signal configured in the upper RU and the reference signal configured in the lower RU) as a second specific resource position at which a radio signal is muted in the cell #1 (STEP 1). Then, the base station 10 determines the resource position which is not muted among the resource positions of a plurality of reference signals in the cell #1 (that is, the resource position of the reference signal configured in the lower RU) as a first specific resource position at which a radio signal is muted in the cell #2 (STEP2). In the example of FIG. 14, since the numerologies of the cell #1 and the cell #2 are different from each other, the positions of the resource elements of the cell #1 and the cell #2 are not identical. Accordingly, the base station 10 determines the first specific resource position at which a radio signal is muted in the cell #1 within the range including all the resource positions that are not muted in at least the cell #2

### Example of Resource Information

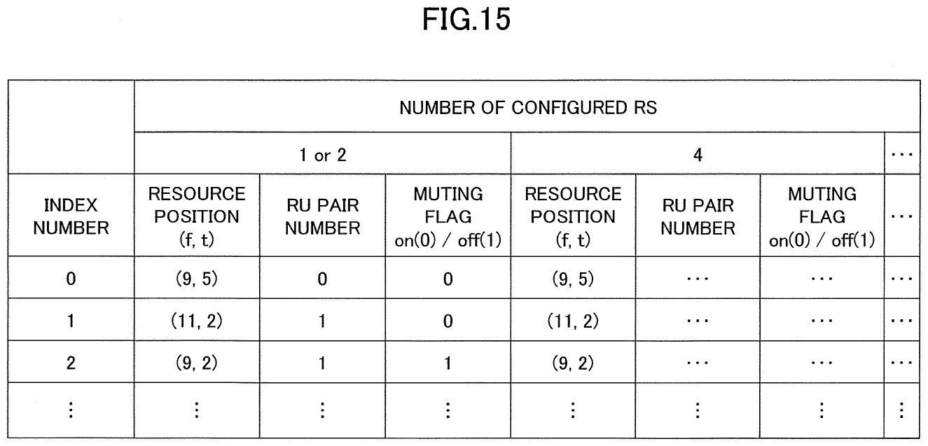

In the resource information transmitted in step S13 of FIG. 4, the resource position at which the base station 10 transmits the reference signal and the first specific resource position at which the base station 10 mutes a radio signal may be specifically indicated or may be indicated using an index number. FIG. 15 illustrates an example of a table illustrating the resource position for each index number.

The “number of RSs to be configured” in FIG. 15 is the number of reference signals configured for each predetermined resource unit. A “resource position” indicates the position of the resource element in which the reference signal is configured in a predetermined resource unit. FIG. 15 illustrates an example in which only the resource element serving as a starting point (for example, only the layer #1 in FIGS. 5 to 14) among the reference signals (the reference signal group) is configured. However, the present invention is not limited thereto, and the positions of the resource elements of all of a plurality of resource elements (for example, all of the layers #1 to #8 in FIGS. 5 to 14) may be configured.

A “RU pair number” is set to make it possible to identify a RU in which the “resource position” indicates the position of the resource element when a predetermined resource unit corresponds to a pair of RUs. In the case of LTE, the “RU number” corresponds to an odd numbered slot number or an even numbered slot number. The “RU number” may be omitted.

A “muting flag” indicates whether the reference signal is transmitted through the resource element indicated by the “resource position” or the resource element indicated by the “resource position” is set to be muted. For example, “0” indicates that the reference signal is transmitted, and “1” indicates that the reference signal is muted.

(Supplemental Items Related to Processing Procedure)

In the resource information, the resource position at which the base station 10 transmits the reference signal and the resource position at which the base station 10 mute the radio signal may not be clearly distinguished from each other. For example, in FIG. 15, the “muting flag” may be omitted. In this case, the user equipment UE simply measures the reception quality of the designated resources (for example, the reception power, etc.) and reports the measured reception quality to the base station 10 regardless of whether the user equipment UE receives the reference signal at the resource position designated by the resource information and measures it or measures the interference wave from the neighbor cell. Accordingly, the measurement process performed by the user equipment UE can be simplified. In contrast, since the base station 10 is aware of whether the reference signal is transmitted or muted at each resource position, the base station 10 can detect whether the reported reception quality is the reception quality related to the reference signal or the reception quality related to the interference wave.

The processing procedure performed in the radio communication system according to the embodiment is described above. According to the processing procedure described above, it is possible to prevent the radio signal from being transmitted at the resource position in which the reference signal is transmitted in the neighbor cell, and the user equipment UE can measures the interference amount appropriately and reports the measured interference amount to the base station 10. Further, according to the processing procedure described above, it is possible to prevent the radio signal from being transmitted in the neighbor cell at the resource position in which the reference signal is transmitted in its own cell, and the user equipment UE can appropriately measure the reception quality of the serving cell and report the measured reception quality to the base station 10.

<Functional Configuration>

### (Base Station)

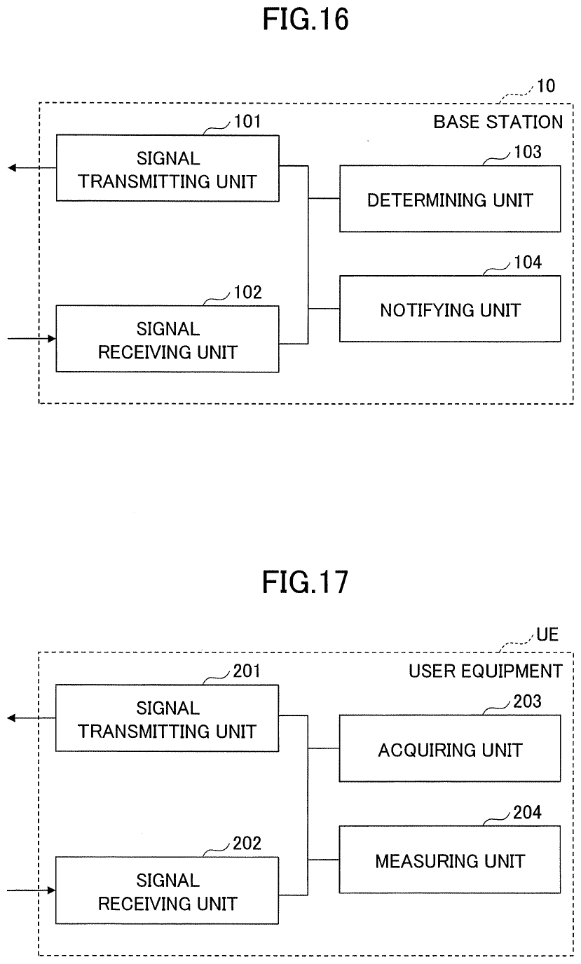

FIG. 16 is a diagram illustrating an example of a functional configuration of the base station according to the embodiment. As illustrated in FIG. 16, the base station 10 includes a signal transmitting unit 101, a signal receiving unit 102, a determining unit 103, and a notifying unit 104. FIG. 16 illustrates only functional units of the base station 10 particularly related to the embodiment of the present invention, and functions (not illustrated) of performing operations conforming to 5G (including LTE) are also provided. Further, the functional configuration illustrated in FIG. 16 is merely an example. Any functional division or any name may be used as long as the operation according to the preset embodiment can be performed.

The signal transmitting unit 101 has a function of generating various kinds of signals of the physical layer from signals of a higher layer to be transmitted from the base station 10 and wirelessly transmitting the signals. The signal receiving unit 102 has a function of receiving various types of radio signals from the user equipment UE and retrieving a signal of the higher layer from the received signal of the physical layer.

Further, the signal transmitting unit 101 includes a function of transmitting a radio signal in the first cell by mapping the first reference signal onto a resource at a first resource position of a first reference signal configured in the first cell and muting a specific resource at a first specific resource position at which a radio signal is muted in the first cell.

Further, the signal transmitting unit 101 may transmit a data channel signal instead of a part of a plurality of reference signals when the first specific resource position at which the radio signal is determined to be muted in the first cell by the determining unit 103 does not overlap the resource position at which the reference signal is configured in a predetermined resource unit of the first cell, and a plurality of reference signals is configured in the predetermined resource unit of the first cell.

Further, the signal transmitting unit 101 may transmit a data channel signal at a part of the first resource position at which a radio signal is muted in the first cell.

The determining unit 103 is provided with a function of determining the first specific resource position at which a radio signal is muted in the first cell based on the resource position of the first reference signal configured in the first cell, the first resource allocation of the first cell (the resource allocation based on the numerology of the first cell), the second resource position of the second reference signal configured in the second cell, and the second resource allocation of the second cell (the resource allocation based on the numerology of the second cell).

Further, when a plurality of reference signals are configured in a predetermined resource unit of the first cell (for example, a pair of RUs), the determining unit 103 may determine the resource positions of a part of reference signals among the resource positions of the plurality of reference signals as the first specific resource position at which a radio signal is muted in the first cell and determine the resource position at which the reference signal other than the reference signals of the part of the reference signals among the plurality of reference signals as the second specific resource position at which a radio signal is muted in the second cell.

Additionally, the determining unit 103 may identify, among predetermined resource units of the first cell, a resource including a resource position at which a reference signal is configured in the second cell by comparing information indicating a first resource allocation configured in the first cell with a second resource allocation configured in the second cell; the determining unit 103 may determine the identified resource as a first specific resource position at which a radio signal is muted in the first cell; and, when a plurality of reference signals is configured in the first cell based on the predetermined resource units of the first cell, the determining unit 103 may determine a resource position at which a part of the plurality of reference signals is transmitted as a second specific resource position at which a radio signal is muted in the second cell.

The notifying unit 104 is provided with a function of transmitting the resource information to the user equipment UE. Additionally, the notifying unit 104 may be provided with a function of transmitting the resource position determined by the determining unit 103 to other base stations 10 via the inter-base station interface.

(User Equipment)

FIG. 17 is a diagram illustrating an example of a functional configuration of the user equipment according to the embodiment. As illustrated in FIG. 17, the user equipment UE includes a signal transmitting unit 201; a signal receiving unit 202; an acquiring unit 203; and a measuring unit 204. FIG. 17 illustrates only functional parts of the user equipment UE particularly related to the embodiment of the present invention, and functions (not illustrated) of performing at least operations conforming to 5G (including LTE) are also provided. Further, the functional configuration illustrated in FIG. 17 is merely an example. Any functional division or any name may be used as long as the operation according to the preset embodiment can be performed.

The signal transmitting unit 201 is provided with a function of generating various types of signals of the physical layer from signals of a higher layer to be transmitted from the user equipment UE and wirelessly transmitting the signals. The signal receiving unit 202 is provided with a function of wirelessly receiving various types of signals from the base station 10 and acquiring a signal of the higher layer from the received signal of the physical layer.

The acquiring unit 203 is provided with a function of obtaining the resource information from the base station 10.

The measuring unit 204 is provided with a function of performing the quality measurement of the reference signal of the serving cell at the resource position designated by the resource information acquired by the acquiring unit 203 and measuring the interference amount from the adjacent cell by measuring the muted resources. The measuring unit 204 also has a function of reporting the measurement result to the base station 10.

<Hardware Configuration>

In the block diagrams (FIGS. 16 and 17) used in the description of the above embodiment, the blocks of the functional units are illustrated. The functional blocks (configuring units) are implemented by any combination of hardware and/or software. A device of implementing each functional block is not particularly limited. In other words, each functional block may be implemented by one device which is physically and/or logically combined or may be implemented by a plurality of devices, that is, two or more devices which are physically and/or logically separated and are directly and/or indirectly connected (for example, a wired and/or wireless manner).

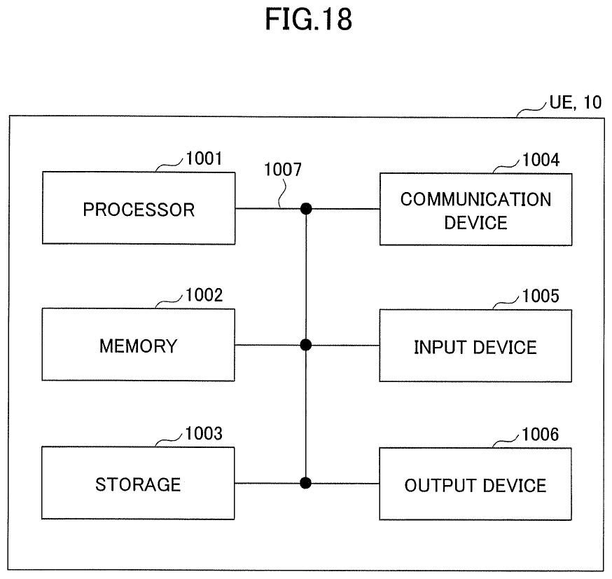

For example, each of the base station 10 and the user equipment UE in one embodiment of the present invention may function as a computer that performs the process of the signal transmission method of the present invention. FIG. 18 is a block diagram illustrating a hardware configuration of each of the base station 10 and the user equipment UE according to one embodiment of the present invention. Each of the base station 10 and the user equipment UE described above may be physically configured as a computer device that includes a processor 1001, a memory 1002, a storage 1003, a communication device 1004, an input device 1005, an output device 1006, a bus 1007, and the like.

In the following description, the term “device” can be replaced with a circuit, a device, a unit, or the like. The hardware configuration of each of the base station 10 and the user equipment UE may be configured to include one or more devices illustrated in the drawing or may be configured without including some devices.

Each function in each of the base station 10 and the user equipment UE is implemented such that predetermined software (program) is read on hardware such as the processor 1001 and the memory 1002, and the processor 1001 performs an operation and controls communication by the communication device 1004 and reading and/or writing of data in the memory 1002 and the storage 1003.

For example, the processor 1001 operates an operating system and controls the entire computer. The processor 1001 may be configured with a central processing unit (CPU) including an interface with a peripheral device, a control device, an operation device, a register, and the like. For example, the signal transmitting unit 101, the signal receiving unit 102, the determining unit 103, and the notifying unit 104 of the user equipment UE and the signal transmitting unit 201, the signal receiving unit 202, the acquiring unit 203, and the measuring unit 204 of the base station 10 may be implemented by the processor 1001.

Further, the processor 1001 reads a program (a program code), a software module, and data from the storage 1003 and/or the communication device 1004 out to the memory 1002, and performs various kinds of processes according to them. A program causing a computer to execute at least some of the operations described in the above embodiment is used as the program. For example, the signal transmitting unit 101, the signal receiving unit 102, the determining unit 103, and the notifying unit 104 of the user equipment UE and the signal transmitting unit 201, the signal receiving unit 202, the acquiring unit 203, and the measuring unit 204 of the base station 10 may be implemented by a control program which is stored in the memory 1002 and operates on the processor 1001, or the other functional blocks may be similarly implemented. Various types of processes are described as being performed by one processor 1001 but may be performed simultaneously or sequentially by two or more processors 1001. The processor 1001 may be implemented by one or more chips. The program may be transmitted from a network via an electric communication line.

The memory 1002 is a computer readable recording medium and configured with at least one of a read only memory (ROM), an erasable programmable ROM (EPROM), an electrically erasable programmable ROM (EEPROM), a random access memory (RAM), etc. The memory 1002 is also referred to as a “register,” a “cache,” a “main memory,” or the like. The memory 1002 can store programs (program codes), software modules, or the like which are executable for carrying out the signal transmission method according to an embodiment of the present embodiment.

The storage 1003 is a computer-readable recording medium and may be configured with, for example, at least one of an optical disk such as a compact disc ROM (CD-ROM), a hard disk drive, a flexible disk, a magneto-optical disk (for example, a compact disk, a digital versatile disk, or a Blu-ray (registered trademark) disc, a smart card, a flash memory (for example, a card, a stick, or a key drive), a floppy (registered trademark) disk, a magnetic strip, and the like. The storage 1003 is also referred to as an “auxiliary storage device.” The storage medium may be, for example, a database, a server, or any other appropriate medium including the memory 1002 and/or the storage 1003.

The communication device 1004 is hardware (a transmitting and receiving device) for performing communication between computers via a wired and/or wireless network and is also referred to as a “network device,” a “network controller,” a “network card,” a “communication module,” or the like. For example, the signal transmitting unit 101 and the signal receiving unit 102 of the base station 10 and the signal transmitting unit 201 and the signal receiving unit 202 of the user equipment UE may be implemented by the communication device 1004.

The input device 1005 is an input device that receives an input from the outside (such as a keyboard, a mouse, a microphone, a switch, a button, a sensor, or the like). The output device 1006 is an output device that performs an output to the outside (for example, a display, a speaker, an LED lamp, or the like). The input device 1005 and the output device 1006 may be integrated (for example, a touch panel).

The devices, such as the processor 1001 and the memory 1002, may be connected via the bus 1007 to communicate information with each other. The bus 1007 may be configured with a single bus or may be configured with different buses between the devices.

Further, each of the base station 10 and the user equipment UE may be configured to include hardware such as a microprocessor, a digital signal processor (DSP), an application specific integrated circuit (ASIC), a programmable logic device (PLD), or a field programmable gate array (FPGA) or all or some of the functional blocks may be implemented by hardware. For example, the processor 1001 may be implemented by at least one of these hardware components.

### CONCLUSION

As described above, according to the embodiments, there is provided a base station of a radio communication system provided with a plurality of cells, the base station including a determiner that determine a first specific resource position at which a radio signal is muted in a first cell, based on a first resource position of a first reference signal configured in the first cell, a first resource allocation of the first cell, a second resource position of a second reference signal configured in a second cell, and a second resource allocation of the second cell; and a transmitter that transmits the radio signal in the first cell, while mapping the first reference signal onto a first resource at the first resource position of the first reference signal configured in the first cell, and muting a specific resource at the first specific resource position at which the radio signal is muted in the first cell. According to the base station 10, a technique is provided that allows the user equipment to appropriately measure the reference signal and the interference signal in accordance with a numerology applied to each cell.

Furthermore, when a plurality of reference signals is configured in a predetermined resource unit of the first cell, the determiner may determine, among resource positions of the plurality of reference signals, a resource position of a part of the plurality of reference signals as the first specific resource position at which a radio signal is muted in the first cell, and the determiner may determine a resource position for transmitting a reference signal other than the part of the plurality of reference signals as a second specific resource position at which a radio signal is muted in the second cell. As a result, a radio signal is muted at the part of the resource position of the first cell, so that the user equipment UE can measure an interference amount from the second cell. Additionally, at least in the second cell, a radio signal is muted at a resource position at which a reference signal is transmitted in the first cell, so that the user equipment UE residing in the second cell can more properly measure an interference amount from the first cell.

Furthermore, the determiner may identify, within a predetermined resource unit of the first cell, a resource including a resource position at which a reference signal is configured in the second cell by comparing information indicating the first resource allocation configured in the first cell with the second resource allocation configured in the second cell; the determiner may determine the identified resource as the first specific resource position at which the radio signal is muted in the first cell; and, when a plurality of reference signals is configured in the predetermined resource unit in the first cell, the determiner may determine a resource position at which a part of the plurality of reference signals is transmitted, as a second specific resource position at which a radio signal is muted in the second cell. As a result, in the first cell, the radio signal is muted at the resource position at which the reference signal is transmitted in the second cell, and thus the user equipment UE can more appropriately measure the interference amount from the second cell. Furthermore, at least in the second cell, the radio signal is muted at the resource position at which the reference signal is transmitted in the first cell, and thus the user equipment UE residing in the second cell can more appropriately measures the interference amount from the first cell.

Furthermore, when the first specific resource position determined by the determiner at which a radio signal is muted in the first cell does not overlap, in the predetermined resource unit of the first cell, a resource position at which a reference signal is configured in the predetermined resource unit of the first cell, and when a plurality of reference signals is configured in the predetermined resource unit of the first cell, the transmitter may transmit a data channel signal instead of the part of the plurality of reference signals. As a result, the base station eNB can increase a data amount that can be transmitted in downlink.

Furthermore, the transmitter may transmit a data channel signal at a part of the first specific resource position at which a radio signal is muted in the first cell. As a result, the base station eNB can increase a data amount that can be transmitted in downlink.

Furthermore, according to the embodiments, there is provided a signal transmission method executed by a base station of a radio communication system provided with a plurality of cells, the method including a step of determining a first specific resource position at which a radio signal is muted in a first cell, based on a first resource position of a first reference signal configured in the first cell, a first resource allocation of the first cell, a second resource position of a second reference signal configured in a second cell, and a second resource allocation of the second cell; and a step of transmitting the radio signal in the first cell, while mapping the first reference signal onto a first resource at the first resource position of the first reference signal configured in the first cell, and muting a specific resource at the first specific resource position at which the radio signal is muted in the first cell. According to this signal transmission method, there is provided a technique that allows the user equipment to appropriately measure a reference signal and an interference signal in accordance with a numerology applied to each cell.

### Supplemental Embodiments

The data channel may be referred to as a physical downlink shared channel, a downlink data channel, or a Physical Downlink Shared Channel (PDSCH). The RU may be referred to as a RB, a subband, a scheduling unit, or a frequency unit.

A notification of the resource information is not limited to the aspect/embodiment described in this specification and the notification of the resource information may be performed by any other method. For example, the notification of the resource information may be performed by physical layer signaling (for example, Downlink Control Information (DCI), uplink control information (UCI)), higher layer signaling (for example, radio resource control (RRC) signaling, medium access control (MAC) signaling, broadcast information (master information block (MIB), system information block (SIB))), other signals, or a combination thereof. Further, the RRC signaling may be referred to as an “RRC message” and may be, for example, an RRC connection setup message, an RRC connection reconfiguration message, etc.

The embodiments described in this specification are applicable to LTE, LTE-A, SUPER 3G, IMT-Advanced, 4G, 5G, future radio access (FRA), W-CDMA (registered trademark), GSM (registered trademark), CDMA2000, ultra mobile broadband (UMB), IEEE 802.11 (Wi-Fi), IEEE 802.16 (WiMAX), IEEE 802.20, ultra-wideband (UWB), Bluetooth (registered trademark), and systems using any other appropriate systems and/or next generation systems expanded on the basis of the systems.

The processing procedures, the sequences, the flowcharts, and the like of the respective aspects/embodiments described in this specification may be reversed in order provided that there is no contradiction. For example, the method described in this specification presents elements of various steps in an exemplary order and is not limited to the presented specific order.

Input and output resource information and the like may be stored in a specific place (for example, a memory) or may be managed through a management table. Input and output information and the like may be overwritten, updated, or additionally written. Output information and the like may be deleted. Input information and the like may be transmitted to another device.

The base station can accommodate one or more (for example, three) cells (also referred to as “sectors”). When the base station accommodates a plurality of cells, the entire coverage area of the base station can be divided into a plurality of smaller areas, and each smaller area can provide communication service through a base station subsystem (for example, a small indoor base station remote radio head (RRH)). The term “cell” or “sector” refers to part or all of the coverage area of the base station and/or the base station subsystem that performs communication service in the coverage. Furthermore, the terms “base station,” “eNB,” “cell,” and “sector” can be used interchangeably in this specification. The base station is also referred to as a fixed station, a Node B, eNode B (eNB), an access point, a Femto cell, a small cell, or the like.

The mobile station UE is also referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or other appropriate terms, depending on those having skill in the art.

The terms “determining” and “deciding” used in this specification may include a wide variety of actions. For example, “determining” and “deciding” may include, for example, events in which events such as judging, calculating, computing, processing, deriving, investigating, looking up (for example, looking up in a table, a database, or another data structure), or ascertaining are regarded as “determining” or “deciding.” Further, “determining” and “deciding” may include, for example, events in which events such as receiving (for example, receiving information), transmitting (for example, transmitting information), input, output, or accessing (for example, accessing data in a memory) are regarded as “determining” or “deciding.” Further, “determining” and “deciding” may include, for example, events in which events such as resolving, selecting, choosing, establishing, or comparing are regarded as “determining” or “deciding.” In other words, “determining” and “deciding” may include events in which a certain operation is regarded as “determining” or “deciding.”

A reference signal may be abbreviated as RS and may be called a pilot, depending on a standard to be applied.

A phrase “on the basis of” used in this specification is not limited to “on the basis of only” unless otherwise stated. In other words, a phrase “on the basis of” means both “on the basis of only” and “on the basis of at least.”

Any reference to an element using a designation such as “first,” “second,” or the like used in this specification does not generally restrict quantities or an order of those elements. Such designations can be used in this specification as a convenient method of distinguishing between two or more elements. Thus, reference to the first and second elements does not mean that only two elements can be adopted there, or first element must precede the second element in a certain form.

“Include,” “including,” and variations thereof are intended to be comprehensive, similar to a term “comprising” as long as the terms are used in this specification or claims set forth below. Furthermore, the term “or” used in this specification or claims set forth below is intended not to be an exclusive disjunction.

Determination or decision may be made by a value (0 or 1) represented by one bit, may be made by a Boolean value (Boolean: true or false), and may be made by comparison of numerical values (comparison with a predetermined value, for example).

Note that the terms described in this specification and/or the terms necessary for understanding of this specification may be replaced with terms having the same or similar meaning. For example, the channel and/or symbol may be signaling (signal). Furthermore, a signal may be a message.

Information, signals, and the like described in the present specification may be represented using any of various other techniques. For example, data, instructions, commands, information, signals, bits, symbols, chips, and the like mentioned in the entire description may be represented by voltage, current, electromagnetic waves, magnetic field or magnetic particles, optical field or photons, or any combination thereof.

In the present disclosure, for example, when an article such as “a,” “an,” or “the” in English is added by a translation, such an article is assumed to include the plural unless it is obviously indicated that such an article does not include the plural.

Each aspect/embodiment described in this specification may be used alone, may be used in combination, or may be switched in association with execution. Further, a notification of predetermined information (for example, a notification indicating “being X”) is not limited to one which is performed explicitly and may be performed implicitly (for example, a notification of predetermined information is not given).

Although the present invention is described above in detail, it is obvious to those skilled in the art that the present invention is not limited to the embodiments described in this specification. The present invention can be implemented as modifications and alterations without departing from the gist and scope of the present invention defined in claims set forth below. Accordingly, the description of this specification is intended to be exemplary and does not have any restrictive meaning to the present invention.

This international patent application is based on and claims priority to Japanese Patent Application No. 2016-158270 filed on Aug. 10, 2016, and the entire content of Japanese Patent Application No. 2016-158270 is incorporated herein by reference.

### LIST OF REFERENCE SYMBOLS

10 base station
UE user equipment
101 signal transmitting unit
102 signal receiving unit
103 determining unit
104 notifying unit
201 signal transmitting unit
202 signal receiving unit
203 acquiring unit
204 measuring unit
1001 processor
1002 memory
1003 storage
1004 communication device
1005 input device
1006 output device

1. A base station of a radio communication system provided with a plurality of cells, the base station comprising:
a determiner that determines a first specific resource position at which a radio signal is muted in a first cell, based on a first resource position of a first reference signal configured in the first cell, a first resource allocation of the first cell, a second resource position of a second reference signal configured in a second cell, and a second resource allocation of the second cell; and
a transmitter that transmits the radio signal in the first cell, while mapping the first reference signal onto a first resource at the first resource position of the first reference signal configured in the first cell, and muting a specific resource at the first specific resource position at which the radio signal is muted in the first cell.

2. The base station according to claim 1,
wherein, when a plurality of reference signals is configured in a predetermined resource unit of the first cell, the determiner determines, among resource positions of the plurality of reference signals, a resource position of a part of the plurality of reference signals as the first specific resource position at which a radio signal is muted in the first cell, and the determiner determines a resource position for transmitting a reference signal other than the part of the plurality of reference signals as a second specific resource position at which a radio signal is muted in the second cell.

3. The base station according to claim 1,
wherein the determiner identifies, within a predetermined resource unit of the first cell, a resource including a resource position at which a reference signal is configured in the second cell by comparing information indicating the first resource allocation configured in the first cell with the second resource allocation configured in the second cell; the determiner determines the identified resource as the first specific resource position at which the radio signal is muted in the first cell; and,
when a plurality of reference signals is configured in the predetermined resource unit in the first cell, the determiner determines a resource position at which a part of the plurality of reference signals is transmitted, as a second specific resource position at which the radio signal is muted in the second cell.

4. The base station according to claim 3,
wherein, when the first specific resource position determined by the determiner at which a radio signal is muted in the first cell does not overlap, in the predetermined resource unit of the first cell, a resource position at which a reference signal is configured in the predetermined resource unit of the first cell, and when a plurality of reference signals is configured in the predetermined resource unit of the first cell, the transmitter transmits a data channel signal instead of the part of the plurality of reference signals.

5. The base station according to claim 3,
wherein the transmitter transmits a data channel signal at a part of the first specific resource position at which the radio signal is muted in the first cell.

6. A signal transmission method executed by a base station of a radio communication system provided with a plurality of cells, the method comprising:
a step of determining a first specific resource position at which a radio signal is muted in a first cell, based on a first resource position of a first reference signal configured in the first cell, a first resource allocation of the first cell, a second resource position of a second reference signal configured in a second cell, and a second resource allocation of the second cell; and
a step of transmitting the radio signal in the first cell, while mapping the first reference signal onto a first resource at the first resource position of the first reference signal configured in the first cell, and muting a specific resource at the first specific resource position at which the radio signal is muted in the first cell.

7. The base station according to claim 4,
wherein the transmitter transmits a data channel signal at a part of the first specific resource position at which the radio signal is muted in the first cell.
